(19) United States
(12) Patent Application Publication
(10) Pub. No.: US 2017/0340086 A1
(43) Pub. Date: Nov. 30, 2017

(54) A SYSTEM AND METHOD FOR MAKING A TEMPLATE

(71) Applicant: KONINKLIJKE PHILIPS N.V., EINDHOVEN (NL)

(72) Inventor: FOLKERT VRIJBURG, EINDHOVEN (NL)

(21) Appl. No.: 15/532,518

(22) PCT Filed: Dec. 23, 2015
(86) PCT No.: PCT/EP2015/081097

§ 371 Date: Jun. 2, 2017

(30) Foreign Application Priority Data
Jan. 6, 2015 (EP) 15150149.1

(51) Int. Cl. A45D 27/42; B33Y 50/00; B33Y 80/00; B29C 64/386; A45D 44/00; B29L 31/00

(52) U.S. Cl. CPC A45D 27/42; B29C 64/386; A45D 44/005; B33Y 50/00; B33Y 80/00; B29L 2031/7186

(57) ABSTRACT

A system for making a template for printing a bespoke shaving mask that conforms to the shape of a portion of an individual's head or face is disclosed, wherein the bespoke shaving mask being positionable on said head or face to enable a desired hair style to be achieved during shaving. The system comprises a user input, data store and processor. The user input is arranged to receive a user selection of a desired facial hair style from a plurality of facial hair styles. The data store is arranged to store data representing a three dimensional scan of the user's head or face. The processor is arranged to map data representing said selected facial hair style onto said data representing said three dimensional scan to generate said template. Supplementary to the system there is required, a three dimensional scanner for producing the data representing a three dimensional scan of the user's head or face, and a three dimensional printer configured so as to print the bespoke shaving mask.

### FIELD OF THE INVENTION

The present invention relates to a system and method for making a template for printing a bespoke shaving mask that conforms to the shape of a portion of an individual's head or face and to a bespoke shaving mask printed from the template made using the system of the invention.

### BACKGROUND OF THE INVENTION

The styling and trimming of beards requires good hand eye coordination to remove only selected parts of the facial hair so that symmetry and/or a preferred styling contour are maintained. To make the styling process easier, an individual might use a comb as a guide to block areas of the face that they wish to leave unshaven; this helps to leave a neatly defined profile that is more easily replicated side to side. More complex styles are created by shaving complex three dimensional freeform curves into the beard, requiring the individual to have a high level of dexterity and artistic ability.

It is therefore desirable to enable the user of a shaving device to produce a desired hair style with relative ease.

It is known from US2009/0223530 to provide a shaving mask that is attachable to the face and serves as a guide around which facial hair is removed by a trimmer or similar. The guide allows the user to achieve the style of facial hair prescribed by the mask while maintaining good symmetry. US2009/0223530 does not make any provision for making a customised or bespoke mask, thus limiting the user's opportunity to achieve a desired facial hair style.

It is further to be noted that US2009/0151741 discloses a method for creating a customized cosmetic template which method comprises the step of disposing a transfer medium to a part of the face having cosmetics applied thereto, the step of generating an image from an imprint received on the transfer medium, as well as the step of generating a template of the part of the face by forming an aperture in a template medium corresponding to the image.

### SUMMARY OF THE INVENTION

It is an object of the invention to provide a system and method for making a template which substantially alleviates or overcomes the problems mentioned above.

According to an aspect of the invention, there is provided a system for making a template for printing a bespoke shaving mask that conforms to the shape of a portion of an individual's head or face, said bespoke shaving mask being positionable on said head or face to enable a desired hair style to be achieved during shaving, the system comprising: (a) a data store arranged to store data representing a three dimensional scan of the user's head or face; (b) a user input arranged to receive information on a user selection of a desired facial hair style from a plurality of facial hair styles; and (c) a processor arranged to map data representing said selected facial hair style onto said data representing said three dimensional scan to generate said template.

In some embodiments, the system comprises a server and the information on the user selection of the desired facial hair style is received via a network.

In some embodiments, the system further comprises a user interface arranged to receive the user selection of a desired facial hair style from a plurality of facial hair styles.

In some embodiments, the user input, user interface, data store and the processor are comprised in a single apparatus.

In some embodiments, the system comprises a three dimensional scanner arranged to obtain the data representing the three dimensional scan of the user's head or face.

In some embodiments, the system comprises a a three dimensional printer arranged to print a bespoke shaving mask that conforms to the shape of a portion of an individual's head or face, the printer being instructed to print said bespoke shaving mask by the template.

In some embodiments, the template is a set of computer executable instructions adapted to cause the three dimensional printer to print said bespoke shaving mask.

According to an aspect of the invention, there is provided a method of generating a template for printing a bespoke shaving mask that has an interior surface that corresponds to the shape of a portion of an individual's head or face, said bespoke shaving mask being positionable on said head or face to enable a desired facial hair style to be achieved during shaving, the method including: (a) obtaining data representing a three-dimensional scan of the user's head or face; (b) receiving a user selection of a desired facial hair style from a plurality of facial hair styles; (c) mapping data representing said selected facial hair style onto said data representing said three-dimensional scan to generate said template.

In some embodiments, the method comprises using a user interface to receive the user selection of a desired facial hair style from a plurality of facial hair styles.

In some embodiments, the method comprises obtaining data representing a three dimensional scan of the user's head or face using a three dimensional scanner.

According to an aspect of the invention, there is provided a bespoke shaving mask printed from a template generated using the method of the invention, wherein said mask has an inner surface that conforms to the shape of a portion of an individual's head or face.

In some embodiments, the mask comprises cut outs defining regions where hair is to be shaved to achieve a desired facial hair style.

According to an aspect of the invention, there is provided an electric signal carrying computer executable instructions adapted to cause a three dimensional printer to three print a bespoke shaving mask according to any of the above aspects.

According to an aspect of the invention, there is provided a computer readable medium storing computer executable instructions adapted to cause a three dimensional printer to three print a bespoke shaving mask according to any of the above aspects.

According to an aspect of the invention, there is provided a computer readable medium storing computer executable instructions adapted to cause a computer to carry out the method of any of the above aspects.

These and other aspects of the invention will be apparent from and elucidated with reference to the embodiments described hereinafter.

### BRIEF DESCRIPTION OF THE DRAWINGS

Embodiments of the invention will now be described, by way of example only, with reference to the accompanying drawings, in which:

FIG. 1 is an embodiment of the present invention comprising a computer, a computer apparatus and a user interface, in which the computer apparatus is provided by the computer;

FIG. 2 is an embodiment of the present invention comprising a computer, a computer apparatus and a website, in which the computing apparatus is provided by an online server;

FIG. 3 is an embodiment of the present invention comprising a computer, a computer apparatus and a user interface, in which the computing apparatus is provided by an online server;

FIG. 4 is a flow chart depicting the steps necessary for the user to obtain a desired facial hair style.

### DETAILED DESCRIPTION OF EMBODIMENTS

Embodiments of the invention will now be described, by way of example only, with reference to the accompanying drawings.

Embodiments of the present invention provide a system 1 for generating a template for printing a bespoke shaving mask that conforms to the shape of a portion of the user's head or face. The system 1 comprises a data store 2, a user input 3 and a processor 4.

The data store 2 is configured to store information representing a three dimensional scan of the user's head or face; the user input 3 is configured to receive a user selection of a desired facial hair style, and the processor 4 is configured to map the information from the user input 3 onto the data representing the three dimensional scan of the user's head or face to generate a template for three dimensional printing a bespoke shaving mask.

The system 1 may be made accessible to the user by a user interface 5, the user interface 5 being an application or computer program configured to run on any suitable computer 6. Alternatively, the system 1 may be made accessible to the user by a website 7, the website 7 being accessed by an internet browser 9 configured to run on any suitable computer 6. In other embodiments, the functionality provided by the website 7 could be provided by a smartphone app or other suitable network connected hardware or software.

Supplementary to the system 1 there is provided, a three dimensional scanner for generating the three dimensional scan of the user's head or face and a three dimensional printer to print the bespoke shaving mask according to the template generated by the processor 4.

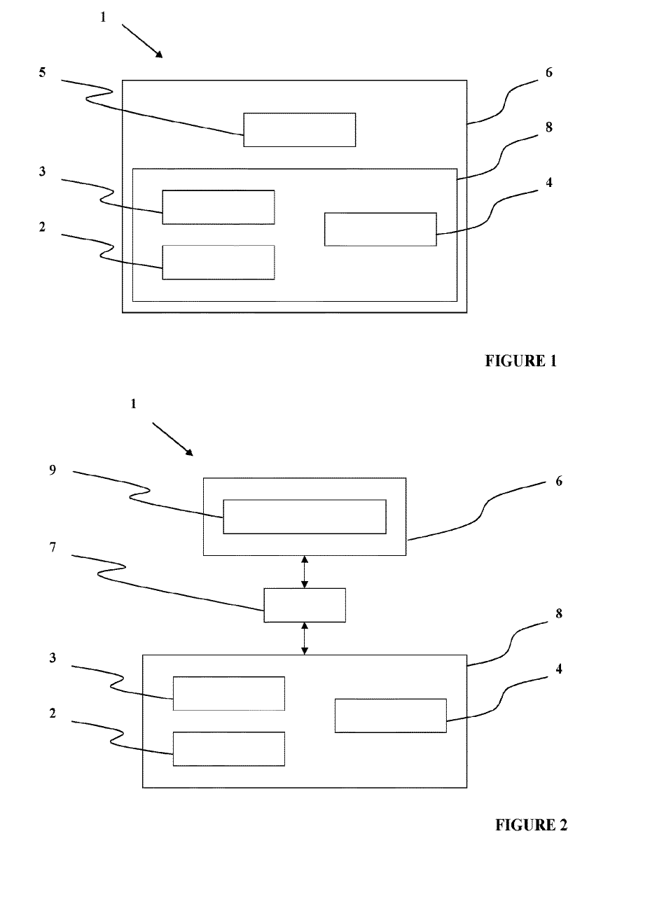

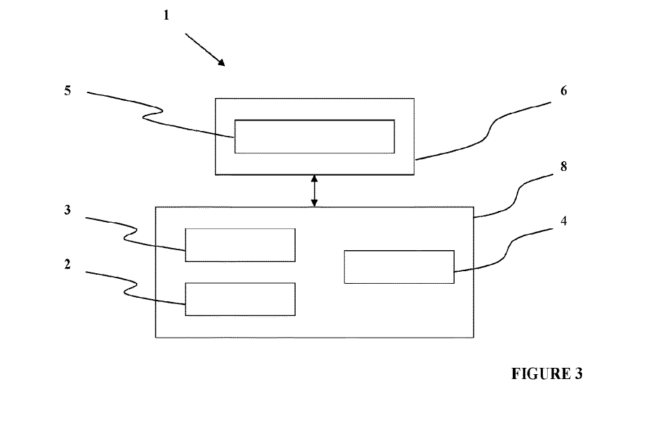

The data store 2, user input 3 and processor 4 are provided by a computing apparatus 8. In a first embodiment, shown in FIG. 1, the computing apparatus 8 may be provided by a computer 6, said computer 6 being the same computer 6 configured to run the user interface 5; such a computer 6 could be a smart phone, tablet, general purpose computer 6 or other suitable computer 6. In a second embodiment, shown in FIG. 2, the computing apparatus 8 is provided by a remote server, connected to the internet, and accessed through a website 7 in the usual way. In a third embodiment, shown in FIG. 3, the computing apparatus 8 is provided by a remote server, connected to the internet, and accessed by a user interface 5 running on any suitable computer 6.

It is intended that the user uses the three dimensional scanner to make a three dimensional scan file that contains information on the shape of their head or face. The three dimensional scan file is then made accessible to the computing apparatus 8 so that the file can be received in the data store 2. The user then inputs their required facial hair style with the user input 3 feature of the system 1 so that said facial hair style is communicable with the processor 4. Upon execution of an appropriate command by the user, the processor 4 combines the information on the user's required facial hair style with the three dimensional scan file received in the data store 2 to map said selected facial hair style onto the three dimensional scan file of the user's head or face. The processor 4 is further configured to interpret the three dimensional scan file and the user's selected facial hair style to generate a set of computer executable instructions, or template, that can be used to instruct a three dimensional printer to print a bespoke shaving mask.

The bespoke shaving mask is configured to have an interior surface to precisely fit a portion the user's head or face, and an outline that the user may use as a guide to shave up against. When in use, the shaving mask covers an area of the user's face that corresponds to the user's selected facial hair style. The user then shaves around the outline of the mask to remove facial hair from areas of the face not covered by the mask. Upon completion of the shaving activity the mask is removed, areas of the face that were covered by the mask are unshaven, such that the desired facial hair style is achieved.

It shall be understood that the mask, in having an interior surface that precisely corresponds to the shape of the user's head or face, provides the inherent advantage that the mask fits the user without needing to be stretched or deformed. As the mask is not stretched or deformed in use, the outline of the mask is preserved so that, following shaving, the user is left with the facial hair style that they were anticipating.

Furthermore, the mask may also comprise cut outs so that facial hair can be removed from areas within the mask's outline. The cut outs may represent a pattern or icon that the user may wish to have cut into their facial hair. Alternatively, the mask may be configured so that facial hair above a threshold length may protrude through the mask. The protruding facial hair is therefore accessible for shaving, so that in shaving over the mask, the user may trim the hair located under the mask back to a length allowed by the thickness of the mask.

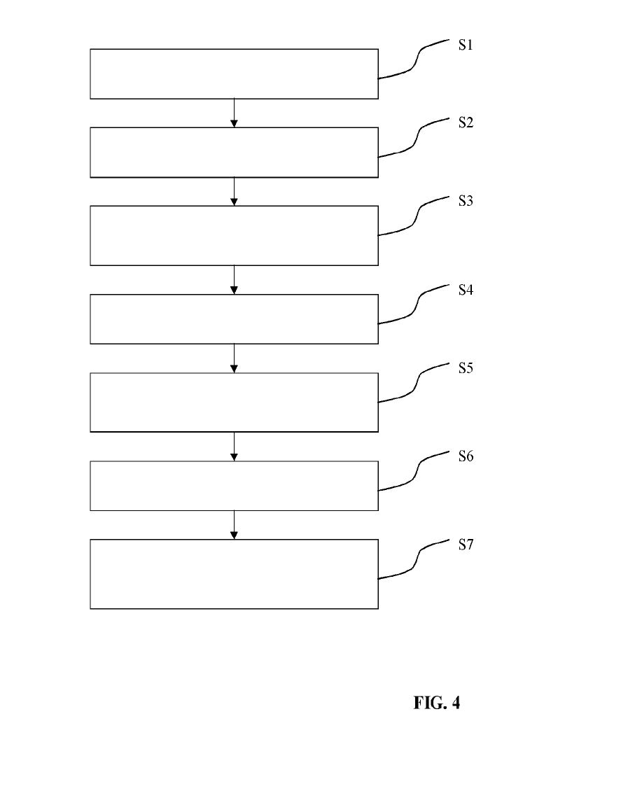

FIG. 4 is a flow chart depicting the stages of a method to generate a template for printing a bespoke shaving mask (Step S2 to Step S5), FIG. 4 further showing steps to obtaining the desired facial hair style as enabled by embodiments of the present invention (Step S1 to Step S7).

In Step S1, the user makes a three dimensional scan of their head or face. In Step S2, the three dimensional scan file is made accessible to the computing apparatus. In Step S3, the user chooses a facial hair style and inputs the facial hair style into the user input. In Step S4 the facial hair style is mapped onto the three dimensional scan. In Step S5, the user instructs the computing apparatus to generate a template for printing a bespoke shaving mask. In Step S6, the user prints the mask using a three dimensional printer. In Step S7, the user applies the mask to their face and shaves around the mask to realise the facial hair style previously designed.

Hence, initially the user makes a three dimensional scan of their face (Step S1). This can be achieved using a portable computing device, such as a tablet or smart phone, retrofitted with a three dimensional scanner. Alternatively, a dedicated three dimensional scanner/camera may be used, the three dimensional scanner/camera being a portable device, or a photo booth. These devices provide the user with a three dimensional scan file.

The three dimensional scan file may equally well be created using a conventional camera and a computer 6. The three dimensional scan file is generated by the steps of taking multiple photos of the user's head or face from different angles and making them accessible to the computer 6, wherein the computer 6 is configured to process said photos and convert them into a three dimensional scan file. The computer 6 comprises a system 1 having a user input 3 to receive said photos and a processor 4 to convert said photos into the three dimensional scan file. The system 1 is made accessible to the user by a user interface 5, the user interface 5 being an application or computer program, wherein said application or computer program may be the same application or computer program used to access the system 1 used to generate the shaving template.

The user then makes the three dimensional scan accessible to the computing apparatus 8 so that it is received by the data store 2 (Step S2). In the first embodiment, the user uses the user interface 5 to make the three dimensional scan file accessible to the computing apparatus 8, wherein the computing apparatus 8 is provided by the same computer 6 that is configured to run the user interface 5; said computer 6 may be a smart phone, tablet, general purpose computer 6 or other suitable means.

In the second embodiment, the user makes the three dimensional scan file accessible to the computing apparatus 8 through a website 7, wherein the computing apparatus 8 is a remote server connected to the internet. The website 7 is accessed by known means; such means may include using an internet browser 9, wherein the internet browser 9 is configured to run on any suitable computer 6.

In a third embodiment, the user uses with the user interface 5 to make the three dimensional scan file accessible to the computing apparatus 8, wherein the computing apparatus 8 is a remote server connected to the internet. Such an arrangement, whereby a user interface 5 is directly communicable with the internet, is a common feature of applications downloadable for smartphones, tablets and similar devices.

Once the three dimensional scan file is made accessible to the computing apparatus 8, said scan file is received in the system's 1 data store 2 and made communicable with the processor 4.

Once the three dimensional scan file has been received in the data store 2, the user may then use the website 7 or user interface 5 to choose a facial hair style (Step S3). Optionally, the user uses the website 7 or user interface 5 to discretely choose a facial hair style option from a pre-composed list. Alternatively, the website 7 or user interface 5 may be configured to allow the user to create a facial hair style of their design; the design may include information on patterns or icons if desired. The user's selected facial hair design is received by the user input 3 so that it is made available to the processor 4.

In a possible embodiment of the invention, the user may use the website 7 or user interface 5 to map said selected facial hair style onto the three dimensional scan file of the user's head or face in order to preview said facial hair style on a three dimensional image of their face (Step S4).

The system 1 is then instructed by the user to generate the template for printing the bespoke shaving mask (Step S5). Upon said instruction, the processor 4 combines the information on the user's required facial hair style, as received by the user input 3, with the three dimensional scan file received in the data store 2 to generate the template. Should the user require a pattern or icon to be shaved into their facial hair, the processor 4 is configured to retrieve the information on the pattern or icon from the user input 3 and use said information to include corresponding instructions for cut outs in the mask template.

Once the template has been generated, the user is then free to use this template file to instruct a suitable printer to print the mask (Step S6). The printer may be a domestic appliance, in that it is available to use in the user's home, or alternatively, the printer may be a provided by a three dimensional printing service provider.

Once the mask is printed, it may be used in the manner above described to realise the user's chosen facial hair design (Step S7).

It is intended that the mask is made from any material suitable for use with a three dimensional printer, but is most likely to be made from PLA (poly lactic acid) or ABS (Acrylonitrile Butadiene Styrene). Both are plastic materials; PLA has the advantage that it is biodegradeable, whereas ABS is slightly stronger and harder. The material that the mask is made from will most likely depend on the printer used.

As discussed, embodiments of the invention can provide a system for making a template for printing a bespoke shaving mask that conforms to the shape of a portion of an individual's head or face, said bespoke shaving mask being positionable on said head or face to enable a desired hair style to be achieved during shaving, the system comprising: (a) a user input arranged to receive information on a user selection of a desired facial hair style from a plurality of facial hair styles; (c) a data store arranged to store data representing a three dimensional scan of the user's head or face; (b) a processor arranged to map data representing said selected facial hair style onto said data representing said three dimensional scan to generate said template.

It will be appreciated that the hardware used by embodiments of the invention can take a number of different forms. For example, all the components of the system could be provided by a single device (e.g. the example of FIG. 1), or different components of the system could be provided on separate devices. Examples of such arrangements are the system of FIG. 2, in which a number of the components of the respective systems are provided on a device, whereas other components are provided on remote devices (with “remote” in this context meaning not part of the device, but communicable with the device). More generally, it will be appreciated that embodiments of the invention can provide a system that comprises one device or several devices in communication.

In some embodiments, the system may comprise a user interface arranged to receive the user selection of a desired facial hair style from a plurality of facial hair styles. In some embodiments, the user input, user interface, data store and the processor are comprised in a single apparatus. In other embodiments, for example, the user input, data store and the processor may be provided on a server and the user interface may comprise a web browser (or equivalent) on a user's PC (or other internet connected device).

Embodiments of the invention can also provide a method of generating a template for printing a bespoke shaving mask that has an interior surface that corresponds to the shape of a portion of an individual's head or face, said bespoke shaving mask being positionable on said head or face to enable a desired facial hair style to be achieved during shaving, the method including: (a) receiving a user selection of a desired facial hair style from a plurality of facial hair styles; (b) obtaining data representing a three-dimensional scan of the user's head or face; (c) mapping data representing said selected facial hair style onto said data representing said three-dimensional scan to generate said template.

Embodiments of the invention can also provide a bespoke shaving mask printed from a template generated using the method of any embodiments of the invention, wherein said mask has an inner surface that conforms to the shape of a portion of an individual's head or face.

Embodiments of the invention can also provide an electric signal carrying computer executable instructions adapted to cause a three dimensional printer to three print a bespoke shaving mask.

Embodiments of the invention can also provide an computer readable medium storing computer executable instructions adapted to cause a three dimensional printer to three print a bespoke shaving mask.

Embodiments of the invention can also provide a computer readable medium storing computer executable instructions adapted to cause a computer to carry out the method of any embodiments of the invention.

It will be appreciated that the term “comprising” does not exclude other elements or steps and that the indefinite article “a” or “an” does not exclude a plurality. The mere fact that certain measures are recited in mutually different dependent claims does not indicate that a combination of these measures cannot be used to an advantage. Any reference signs in the claims should not be construed as limiting the scope of the claims.

Although claims have been formulated in this application to particular combinations of features, it should be understood that the scope of the disclosure of the present invention also includes any novel features or any novel combinations of features disclosed herein either explicitly or implicitly or any generalisation thereof, whether or not it relates to the same invention as presently claimed in any claim and whether or not it mitigates any or all of the same technical problems as does the parent invention. The applicants hereby give notice that new claims may be formulated to such features and/or combinations of features during the prosecution of the present application or of any further application derived therefrom.

1. A system for making a template of a bespoke shaving mask that conforms to the shape of a portion of a user's head or face, said template suitable for printing the bespoke shaving mask, said bespoke shaving mask being positionable on said head or face to enable a desired hair style to be achieved during shaving, the system comprising:
(a) a data store configured to store data representing a three dimensional scan of the user's head or face;
(b) a user input configured to receive information on a user selection of a desired facial hair style from a plurality of facial hair styles; and
(c) a processor configured to map data representing said selected facial hair style onto said data representing said three dimensional scan to generate said template.

2. A system according to claim 1, wherein the system comprises a server and the information on the user selection of the desired facial hair style is received via a network.

3. A system according to claim 1, further comprising a user interface configured to receive the user selection of a desired facial hair style from a plurality of facial hair styles.

4. A system according to claim 3, wherein the user input, user interface, data store and the processor are comprised in a single apparatus.

5. A system to according to claim 1, comprising a three dimensional scanner configured to obtain the data representing the three dimensional scan of the user's head or face.

6. A system according to claim 1, comprising a three dimensional printer configured to print a bespoke shaving mask that conforms to the shape of a portion of an individual's head or face, the printer being instructed to print said bespoke shaving mask by the template.

7. A system according to claim 6, wherein the template is a set of computer executable instructions adapted to cause the three dimensional printer to print said bespoke shaving mask.

8. A method of generating a template of a bespoke shaving mask that has an interior surface that corresponds to the shape of a portion of an individual's head or face, said template suitable for printing the bespoke shaving mask, said bespoke shaving mask being positionable on said head or face to enable a desired facial hair style to be achieved during shaving, the method including:
(a) obtaining data representing a three-dimensional scan of the user's head or face;
(b) receiving a user selection of a desired facial hair style from a plurality of facial hair styles;
(c) mapping data representing said selected facial hair style onto said data representing said three-dimensional scan to generate said template.

9. A method according to claim 8, further comprising using a user interface to receive the user selection of a desired facial hair style from a plurality of facial hair styles.

10. A method according to claim 8, comprising obtaining data representing a three dimensional scan of the user's head or face using a three dimensional scanner.

11. A bespoke shaving mask printed from a template generated using the method of claim 8, wherein said mask has an inner surface that conforms to the shape of a portion of an individual's head or face.

12. A bespoke shaving mask according to claim 11, comprising cut outs defining regions where hair is to be shaved to achieve a desired facial hair style.

13. An electric signal carrying computer executable instructions adapted to cause a three dimensional printer to three print a bespoke shaving mask according to claim 11.

14. A computer readable medium storing computer executable instructions configured to cause a three dimensional printer to three print a bespoke shaving mask according to claim 11.

15. A computer readable medium storing computer executable instructions adapted to cause a computer to carry out the method of any of claim 8.
